(19) United States
(12) Patent Application Publication
(10) Pub. No.: US 2008/0208808 A1
(43) Pub. Date: Aug. 28, 2008

(54) Configuring searches

(75) Inventors: Ryan E. Sue, Fremont, CA (US); Alan D. Wada, Mountain View, CA (US); Yajun Alex Ou, Fremont, CA (US)

Correspondence Address: HICKMAN PALERMO TRUONG & BECKER LLP/Yahoo! Inc., 2055 Gateway Place, Suite 550, San Jose, CA, 95110-1083, US

(73) Assignee: Yahoo! Inc.

(21) Appl. No.: 11/712,281

(22) Filed: Feb. 27, 2007

(51) Int. Cl. G06F 17/30

(52) U.S. Cl. 707/3; 707/E17.108

(57) ABSTRACT

A GUI is generated to receive parameters that specify properties of a search engine. Certain parameters are received via the user interface, which specify the properties for a certain search engine. The search engine is configured according to the parameters specified. A request for executing the search engine is received and search results generated by executing the search engine are presented, via the GUI. The certain parameters specify each of a set of search engine properties that include the format of the search results returned by the search engine and search domain sources of the search engine.

### TECHNOLOGY

The present invention relates generally to information retrieval, and more specifically, to configuring search engines.

### BACKGROUND

In contrast to broad but relatively shallow keyword-based web searches, more semantically based vertical searches provide enhanced specialization. Vertical searches may be performed in any domain. Thus the number of vertical searches that may be conceived are as virtually unlimited as the number of conceivable domains of specialized knowledge. As vertical searches proliferate therefore, their individual natures become more specialized. Further, users are individuals with their own specialized information interests. An individual user, independently configuring whichever search engine they use to perform each vertical search would conceivably achieve the ideal in semantic focus, domain specialization and deep web penetration. However, substantial barriers that relate to search engine configuration and management deter achieving this ideal.

Search engines are complex systems and their configuration and management is not trivial. A substantial multitude of low level concepts require significant levels of non-trivial expertise from their administrators. Thus, search engine administration is typically accomplished only by individuals knowledgeable and skilled in information retrieval, a specialized field. Search engine administrators must understand information retrieval concepts including content acquisition, identifying and extracting content from web sites, identifying and mapping content from data feeds, calculating relevancy and understanding the effects of various configuration parameters on the overall ordering of search results.

The proliferation of search technology in applications such as vertical search and achieving the ideal of independent configuration thereof by individual users however requires that search engine administration be performed by the individual users. Yet it is unlikely that many of the potential individual users have or will ever attain any significant expertise in information retrieval. Thus, the level of abstraction for configuring search engines remains insufficient to enable individual users who lack the requisite sophistication in information retrieval technology to do so.

Based on the foregoing, it would be useful to simplify the configuration of search engines.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### DESCRIPTION OF THE DRAWINGS

The present invention is illustrated by way of example, and not by way of limitation, in the figures of the accompanying drawings and in which like reference numerals refer to similar elements and in which:

FIG. 1 depicts an example procedure, according to an embodiment of the present invention;

FIG. 2A-H depict example screenshots, according to an embodiment of the present invention; and

FIG. 3 depicts an example computer platform upon which an embodiment of the present invention may be practiced.

### DESCRIPTION OF EXAMPLE EMBODIMENTS

Example embodiments relating to configuring searches are described herein. In the following description, for the purposes of explanation, numerous specific details are set forth in order to provide a thorough understanding of the present invention. It will be apparent, however, that the present invention may be practiced without these specific details. In other instances, well-known structures and devices are referred to without exhaustive treatment, in order to avoid unnecessarily obscuring the present invention.

### Overview

According to an embodiment, a user interface, such as a graphical user interface (GUI), is generated to receive parameters that specify properties of a search engine. An application for generating the GUI or other user interface may be server based and a user may access the GUI from a client computer networked with the server. For instance, the GUI may display user-interactive webpages.

The search engine properties specified with the certain parameters include the format of the search results that are to be returned by the search engine and search domain sources of said search engine. The search engine is configured according to these parameters. The search engine can be executed in response to a receiving a request, such as a query, via the GUI.

Results that are generated by executing the search engine are presented, also via the GUI. In an embodiment, the GUI (or other user interface) includes one or more user controls, with which a user may indicate a search engine property that governs the way search results are ranked.

Embodiments thus simplify the configuration of search engines. An embodiment raises the abstraction level of search engine configuration, which allows their administration to become transparent and accessible. This allows various users to configure search engines according to their preferences, without requiring them to have professional level sophistication in the technologies relating to information retrieval. Embodiments also support iterative search engine configuration. Further, embodiments allow users to observe the behavior of the search engine upon implementation of (or a change in) a configuration setting so as to review the effects thereof on the system, essentially in real time.

Notation and Nomenclature

Some of the terms and phrases used herein have meanings as described in this section, unless specifically stated otherwise.

A search engine is software (executable instructions and data) configurable and/or configured for searching a set of information resources. A computer executing a search engine generates search results for search queries submitted to the search engine.

Search engines often run on servers, referred to herein as search engine servers. A server is a combination of integrated software components (including data) and an allocation of computational resources, such as memory, a node, and procedures on a computer for executing the integrated software components, where the combination of the software and computational resources are dedicated to a particular function. In the case of a search engine server, the server is dedicated to searching for a set of information resources.

Search engines are widely used on the Internet, the World Wide Web (www, Web, WWW, etc.) and other large internetworks and information resource webs. Often, search engines are publicly accessible on servers as web sites, such as those made available with Yahoo™ and Google™ web pages, which are respectively accessible with the links (http://search.yahoo.com/) and (http://www.google.com/).

The set of information resources searched by search engines are referred to herein as documents. A document is any unit of information that may be indexed by search engine indexes. Search engine indexes are described below. Often a document is a file which may contain plain or formatted text, inline graphics, and other multimedia data, and hyperlinks to other documents. Documents may be static or dynamically generated.

Search engines use a search engine index (e.g., one or more), also referred to herein simply as an index, to search for information. Search engine indexes can be directories, in which content is indexed more or less manually, to reflect human observation. More typically, search engine indexes are created and maintained automatically by processes referred to herein as crawlers. Crawlers explore information over the Internet, essentially continuously, looking for as many documents as they may find at locations to which the crawlers are configured to search. Crawlers may follow links from one document to another. A crawler may retrieve (e.g., fetch, download) a web resource (e.g., a page), save an original form of the page or other resource, identify and extract links to other resources, pages, etc. This allows these resources/pages to be subsequently retrieved, as well. Upon retrieving a crawled page or other resource, other forms of information may be extracted from the crawled resources/pages.

The content extracted from the resources/pages retrieved with the crawler may then be indexed. The content of the resources/pages may be indexed (e.g., semantically, conceptually, etc.) in a search index and summarized in databases, typically of significant size. It is these indexes and databases that are actually searched in response to a search query. Thus generally, crawlers acquire content, which is consumed with an indexing process to build indexes.

In one configuration the software for a search engine may be configured to search one set of resources and in another configuration be configured to search another set of resources. Each such configuration is considered to be a different search engine.

Vertical search engines are engines that use indexes that index documents that are limited to a particular domain or particular topic. Vertical search engines may be limited in this way by, for example, configuring a crawler to search specific locations. For example, a crawler for a vertical search engine for recipes may be configured to search sites and/or locations known to hold recipe documents.

The search result generated by a search engine comprises a list of documents and may contain summary information about the document. The list of documents may be ordered. To order a list of documents, a search engine may assign a rank to each document in the list. When the list is ordered by rank, a document with a relatively higher rank may be placed closer to the head of the list than a document with a relatively lower rank. A search engine may rank the documents according to relevance to the search query. Relevance is a measure of how closely the subject matter of a document matches search query terms.

A GUI is an interface that displays graphical user controls (e.g. selection buttons, command buttons, list boxes, labels, text boxes, text input form elements and/or other such selection and input elements). A graphical user control may be comprised of multiple graphical controls. Many kinds of graphical user controls can be manipulated by a user using an input device, such a mouse, to provide input. A graphical user control is typically dedicated to receiving input for a particular selection and/or input element and often displays information about the selection and/or input element and/or what can be entered for it. Graphical user controls such as selection and/or input elements may comprise Hypertext Markup Language (HTML) code. For example, a check box from a set of check boxes may be selected to specify a parameter value associated with the check box. Each check box is displayed with a label indicating a parameter value. In another example, selection may be made from items displayed in a list box. The list box includes a label naming the selection and/or input element and can be manipulated to display and select values to enter for the selection and/or input element.

Any of a variety of techniques that may be used to cause presentation of a user interface to a user are referred to herein as generating a GUI or generating graphical user controls. This may include any of the following. A server transmitting over the Internet statically or dynamically generated web pages to a browser, where execution of the web pages by the browser causes presentation of the GUI. The browser presenting the user interface in response to executing the web pages. A personal computer executing an executable program installed on a computer. The program is a Windows™ based program that presents a GUI to a user when executed. The GUI may transmit user input entered via the GUI to a server.

### Illustrative Embodiment

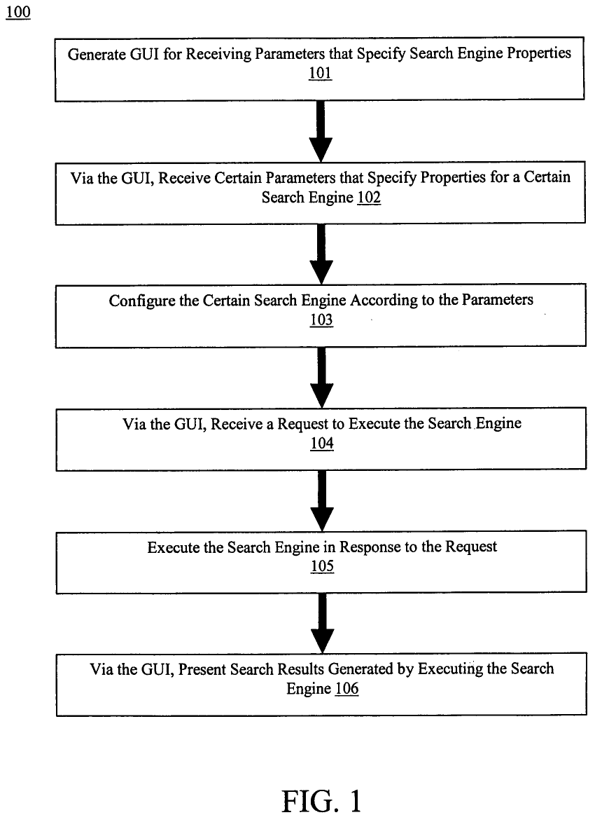

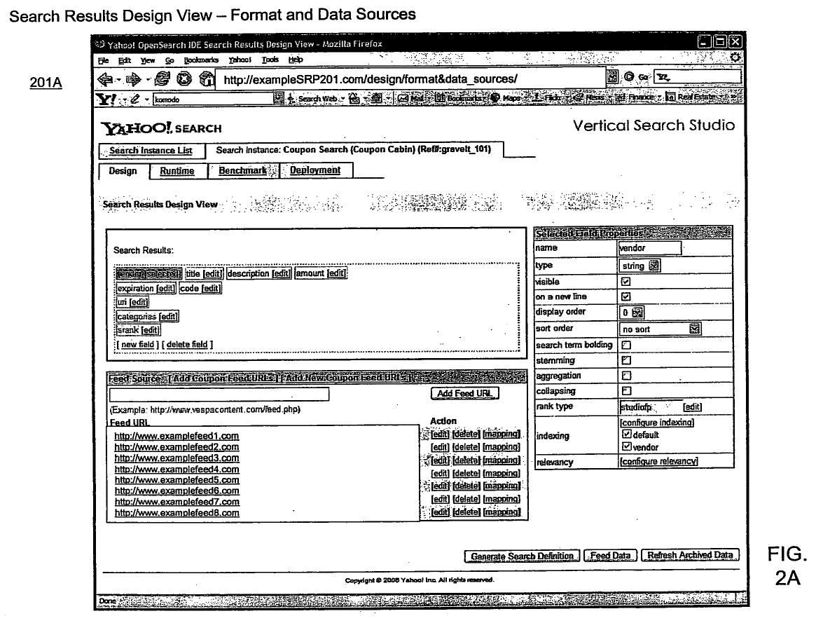

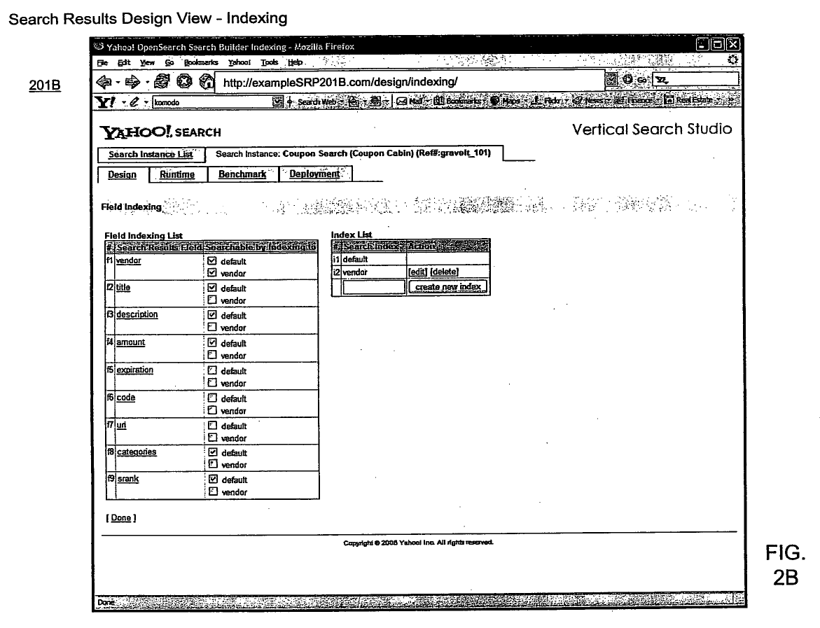

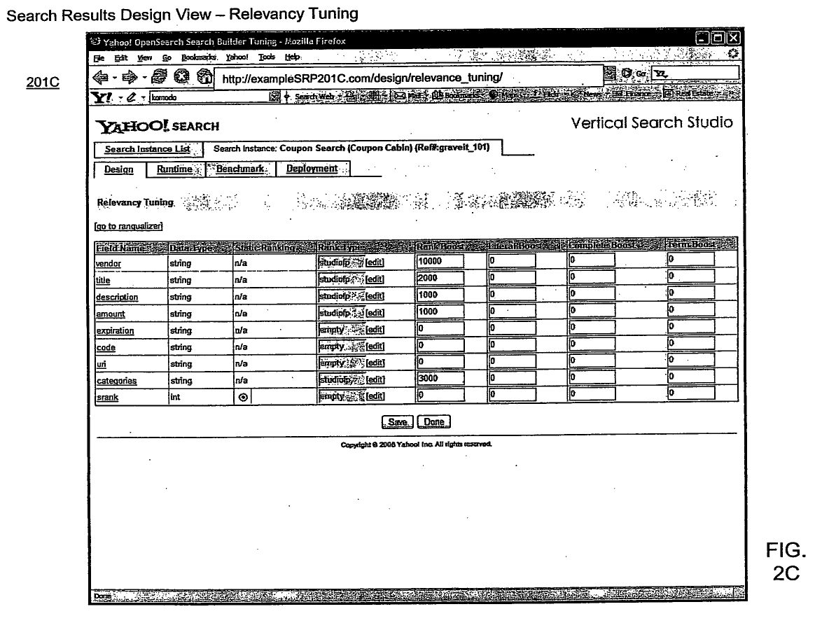

FIG. 1 depicts an example procedure 100, according to an embodiment. Procedure 100 begins with generating 101 a graphical user interface (GUI) for receiving search engine parameters, which specify properties for search engines. In an embodiment, a user interface other than or in addition to the GUI is generated 101. In an embodiment, generating 101 the user interface includes generating one or more user controls that may be manipulated or otherwise controlled by a user to indicate a search engine properties.

In an embodiment, search engine properties include search domain sources. A search domain source may be a search engine index and associated database. A search domain source may also be sources of data to be indexed by search engine indexes, including sites on the Web or Internet, data feeds, databases, and file systems. In an embodiment, search engine properties may also include defining what kinds of data fields are to be presented to end users, the format of data presentation, and/or ranking behavior (e.g., how documents in search engine query results are ranked and ordered and/or presented). In an embodiment, search engine properties for ranking behavior may include weighting factors to be considered relating to term frequency. In an implementation, the weighting factors include ascribing a positive weight for the frequency with which a term is found in a document. This weighting factor may be offset with a negative weight for the frequency with which a term appears in other documents within the search results. For instance, a term frequency/inverse document frequency (TF/IDF) weighting paradigm may be adopted in an implementation.

Certain parameters are received 102 via the GUI, which specify properties for a certain search engine. The user inputs that specify the search engine properties are received 102 in an embodiment by the GUI. The certain parameters specify each of a set of search engine properties, which include the format of the search results that are to be returned by the search engine and search domain sources of said search engine. The certain search engine is configured 103 according to the parameters.

A request is received 104 via the GUI to execute the search engine. For instance, a query may be made with a client based GUI component, to which the certain search engine responds upon receipt thereof from the server based GUI application. The search engine is executed 105 in response to the request. Search results that are generated in executing the search engine are presented 106 via the GUI. For instance, search results responsive to the query may be sent by the server based GUI application and displayed with a client based GUI component for the query-issuing user using a search results web page or the like.

A user reviewing these results may then make a determination as to how the user's search engine configuration suffices to provide information that the user is actually seeking, how close the results obtained are to desired results and/or whether further configuration or configuration changes are desired to achieve sufficiency. Such review may thus be made in real time, which can allow responsive reconfiguration essentially without delay. Embodiments thus allow an iterative approach to configuring search engines. Users are thus free to iteratively configure and reconfigure search engines and, in a sense, to tune the search engine in real time to achieve results that are most compatible with their information retrieval preferences.

Example Interactive Pages

In an embodiment, generating the user interface includes generating a user interface that presents one or more user controls that are manipulated by a user to input a parameter for one or more search engine properties, which govern ranking behavior of the search engine. In an embodiment, generating a user interface for receiving parameters that specify properties of a search engine comprises configuring an interactive search configuration page.

Configuring the search configuration page involves selecting one or more features thereof, which may include a number of rows to be displayed for a search result, fields for each of the search result rows, fields with which the search results are to be sorted and the search domain sources of the search engine. At runtime, the search configuration page accepts one or more queries, displays search results in response to the queries based on the configuration of the search configuration page and explains a ranking, which corresponds to the search results. Further, the search configuration page functions to test the configuration of the search engine according to the parameters input via the GUI.

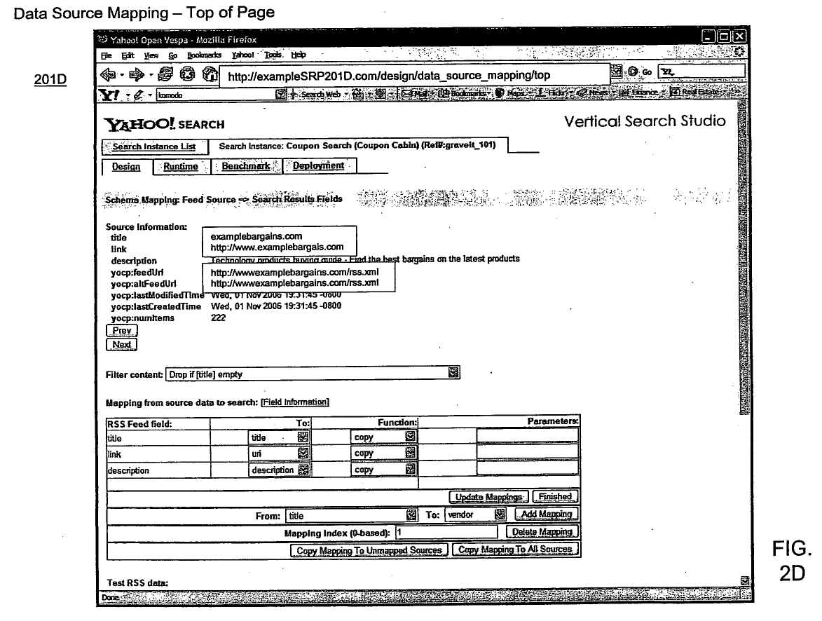

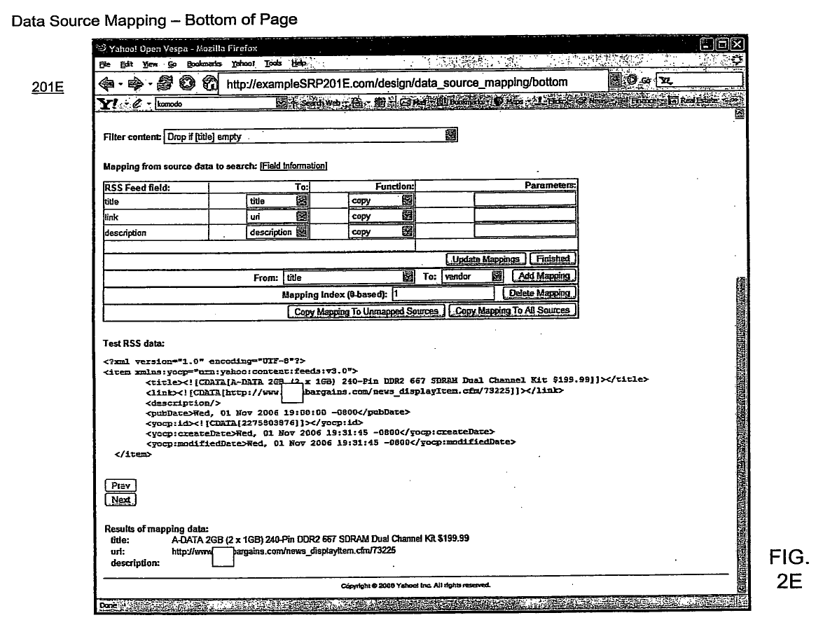

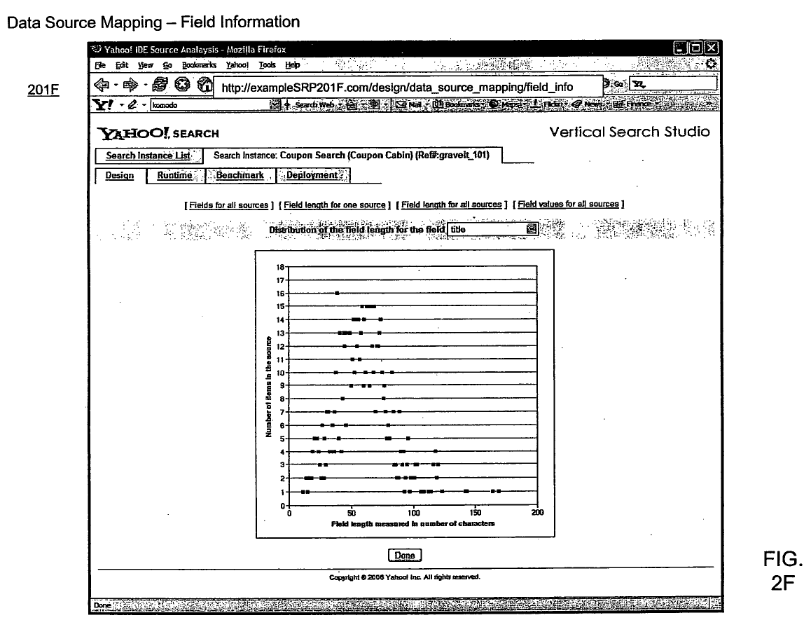

FIG. 2A depicts an example search configuration page 201A, according to an embodiment. With the ‘design’ feature selected as shown, search configuration page 201A displays an interactive design view page for a user to select attributes for search results fields. Via a Design view, a search results field allows a user to structure the information presented for each search result. A user can add fields to search results that will contain information like the title, description, and the uniform resource identifier (URI) for a document. Other fields can be added based on the semantics of the result information, and fields can also be deleted. For example, if the results of a search represent online shopping coupons, then fields like amount, code, and expiration date can be added. Document ranking criteria can also be configured using search results fields. A feed source list allows a user to enter URLs to designate feed sources. Links to designated feed source URLs are displayed with buttons that activate edit, delete and mapping features, with which inputs associated with the links may be made. A properties selection and/or input element allows user inputs. It should be appreciated that, with respect to the example search configuration pages depicted in FIG. 2A-2H, the URLs displayed in address bars and/or various fields are used by way of illustration only and are not limiting. Further, it should be appreciated that the fields and selection and/or input elements depicted in FIG. 2A-2H are shown by way of example and descriptive illustration and are not limiting. Embodiments may be implemented with some, none, any or all of the example fields and selection and/or input elements, as well as any of a variety of other fields and selection and/or input elements than the depicted examples.

FIG. 2B depicts an example search configuration page 201B, according to an embodiment. Search configuration page 201B allows a user to interactively list and index fields. A field indexing list allows designating fields like sources, vendors, titles, descriptions, amounts, expirations, codes, URIs, categories and ranking criteria to be designated as searchable by default or per a vendor. An index list allows creation of new indexes and edit and delete actions for existing indexes like vendor.

FIG. 2C depicts an example search configuration page 201C, according to an embodiment. Search configuration page 201C allows the relevance to be ascribed to search results to be adjusted. For each search result field, a relevancy tuning selection and/or input element allows data types, such as strings, to be identified, a static ranking (if any) to be identified and a ranking type to be edited. The relevancy tuning selection and/or input element allows users to boost ranks and terms and allows literal and complete boosting.

FIG. 2D depicts an example search configuration page 201D, according to an embodiment. Search configuration page 201D displays information relating to data sources and allows a user to interactively map data sources such as really simple syndication (RSS) fields to various search result fields. A source information display element provides source information that includes the title of the source, a link thereto, a description (e.g., of content associated with the information source), URLs associated with a feed (e.g., a normally accessible feed), an alternate feed, the number of items a source comprises, and times associated with a feed's creation and latest modification. A filter selection and/or input element allows a user to input filters to be applied to a content source. Functions can be configured to map content from a data source field (e.g., RSS Feed field) to a search results field. In an implementation, the RSS Feed fields “title,” “link” and “description” are mapped using the copy function to the search results fields “title,” “uri” and “description” respectively.

FIG. 2E depicts an example search configuration page 201E, according to an embodiment. Search configuration page 201E also allows data source mapping and further, displays data received in response to testing data received from these data sources. Search configuration page 201E has selection and/or input elements for a filter and a mapping, which may function as described above in relation to search configuration page 201D (FIG. 2D). In an implementation, search configuration page 201D and search configuration page 201E comprise alternate or extended views of a single search configuration page, e.g., a top and a bottom of a single web page.

FIG. 2F depicts an example search configuration page 201F, according to an embodiment. Search configuration page 201F displays information relating to selected data source fields. Selectable input elements include fields for all sources, the field length for one source, the field length for all sources and field values for all sources. A distribution is displayed for the selected field. As shown, the ‘title’ field is selected and a distribution plot is displayed of the number of items in a source over the length of the field.

In an embodiment, receiving certain parameters that specify the properties for said certain search engine may thus include displaying multiple elements. These elements may include one or more search result fields, a view of properties associated with each of said search result fields, resource requirements corresponding to each of said search result fields and one or more source fields. Configuring a search engine according to the parameters can thus include mapping from one of the source fields to one of the search result fields. Mapping from one of the source fields to one of the search result fields can include visualizing search domain sources and the format of the search results returned by the search engine.

FIG. 2G depicts an example search configuration page 201G, according to an embodiment. A query input element allows a user to enter search terms. With the ‘runtime’ feature selected as shown, search configuration page 201G displays search results for an example query “digital camera.” A link is provided for each search result displayed in the search results section, with which a user can obtain an automated explanation of the relevance, ranking, score, etc. for a particular result. Links (e.g., radio buttons) allow a user to select and to change relevancy preferences, save the results of a particular query, manage one or multiple queries, import popular, successful or other well performing (e.g., top) queries, toggle the markup of fields, judge relevancy and test relevancy.

FIG. 2H depicts an example search configuration page 201H, according to an embodiment. SRP 201H provides an explanation of runtime search results. In an implementation, search configuration page 201H explains the results graphically, such as by graphing the relative contribution to the overall relevance score of a document from each query term, modified or adjusted with a relevancy factor, such as is selected with search configuration page 201C (FIG. 2C). A relevance score comprises a numeric value that represents how closely the subject matter of a document or set of documents matches a search query's terms. The calculation, scale, and numeric range of a relevance score may differ between search engines, as described in co-pending U.S. patent application Ser. No. [to be assigned], filed on [date to be determined] and entitled “Ranking Documents” by Ryan Sue, which is incorporated herein by reference for all purposes as if fully set forth herein. Results may also be displayed as a histogram, such as a plot of ranking scores (e.g., sum, term importance, proximity between terms, terms in the same search result field, query complexity and a static rank) over the ranking of a result. Links allow the graphs, plots, histograms, etc. displayed to be exploded by all search terms combined or by each individual search term, allow details to be obtained for particular terms, and allow navigation to a log of rankings. Multiple results can be explained with additional pages of search configuration page 201H, such as by clicking a page selector or ‘next’ and ‘back’ buttons, etc.

Example Hardware Implementation

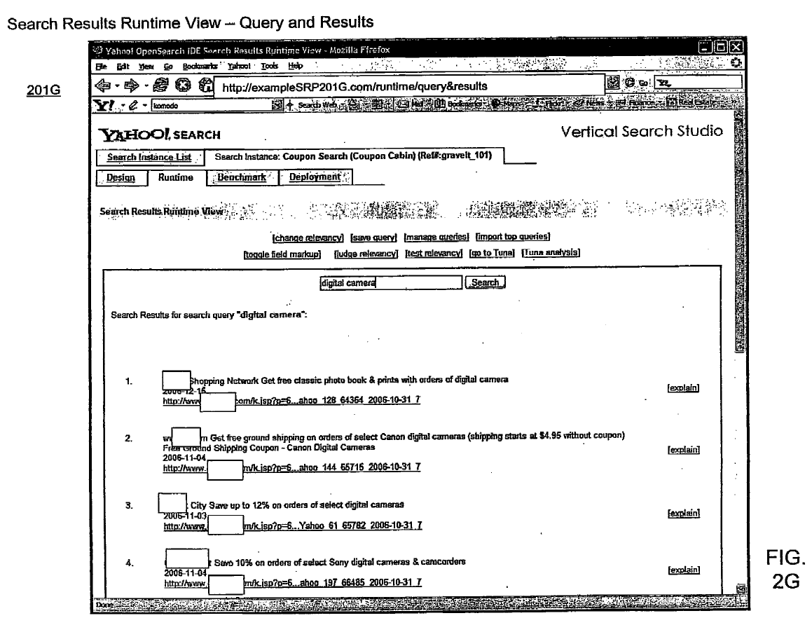

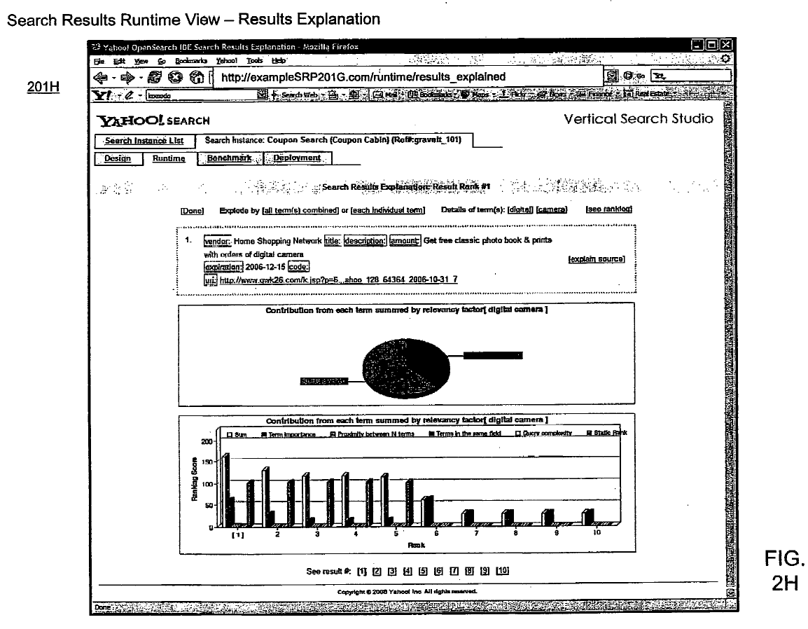

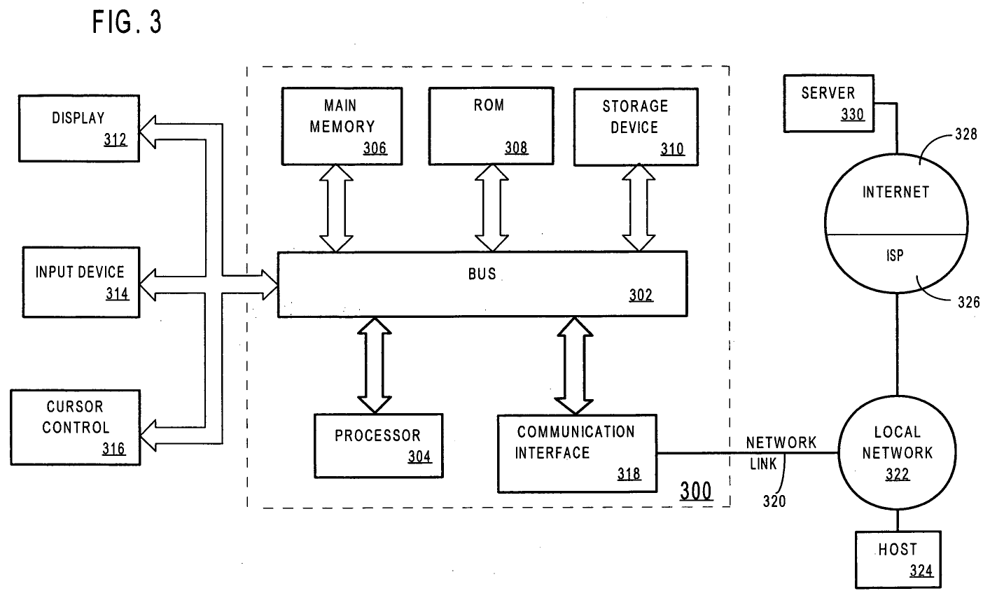

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a liquid crystal display (LCD) or a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for configuring search engines. According to one embodiment of the invention, configuring search engines is provided by computer system 300 in response to processor 304 executing one or more sequences of one or more instructions contained in main memory 306. Such instructions may be read into main memory 306 from another computer-readable medium, such as storage device 310. Execution of the sequences of instructions contained in main memory 306 causes processor 304 to perform the processor steps described herein. One or more processors in a multi-processing arrangement may also be employed to execute the sequences of instructions contained in main memory 306. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium (legacy or other) with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infrared transmitter to convert the data to an infrared signal. An infrared detector coupled to bus 302 can receive the data carried in the infrared signal and place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a digital subscriber link (DSL), cable or other modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the worldwide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318. In accordance with an embodiment, one such downloaded application provides for configuring search engines, as described herein.

The received code may be executed by processor 304 as it is received, and/or stored in storage device 310, or other non-volatile storage for later execution. In this manner, computer system 300 may obtain application code in the form of a carrier wave.

Equivalents, Extensions, Alternatives & Miscellaneous

Thus, example embodiments relating to a readable physical standby database system are described. In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method, comprising:
generating a user interface for receiving parameters that specify properties of a search engine;
via the user interface, receiving certain parameters that specify the properties for a certain search engine;
configuring said certain search engine according to the parameters;
receiving through the user interface, request for execution of said search engine;
presenting, via the user interface, said search results generated by the execution of said search engine;
wherein the certain parameters specify each of a set of search engine properties that include:
the format of the search results returned by the search engine; and
search domain sources of said search engine.

2. The method as recited in claim 1 wherein generating said user interface includes generating one or more user controls for a search engine property that governs ranking behavior of the search engine.

3. The method as recited in claim 1 wherein said user interface comprises a graphical user interface (GUI).

4. The method as recited in claim 1 wherein generating said user interface includes a server generating one or more interactive pages with which the certain parameters and the request to execute the search engine are received and the search results are presented.

5. The method as recited in claim 1 wherein said certain parameters includes at least one parameter that governs selecting one or more features of said interactive pages.

6. The method as recited in claim 5 wherein the one or more features comprises a comprises display of one or more fields for each of said search result rows.

7. The method as recited in claim 5 wherein the one or more features comprises one or more fields with which said search results are to be sorted.

8. The method as recited in claim 5 wherein the one or more features comprises said search domain sources of said search engine.

9. The method as recited in claim 5 wherein the one or more features comprises displaying a layout of said interactive page.

10. The method as recited in claim 4 wherein said interactive page functions at runtime for:
accepting one or more queries;
displaying said search results in response to said one or more queries based the certain parameters; and
explaining a ranking that corresponds to said search results.

11. The method as recited in claim 4 wherein said receiving certain parameters that specify the properties for said certain search engine comprises displaying a plurality of fields wherein said plurality of fields comprises one or more of:
one or more search result fields;
a view of properties associated with each of said result fields;
resource requirements corresponding to each of said result fields; and
one or more source fields.

12. The method as recited in claim 11 wherein said configuring said certain search engine according to the parameters comprises mapping from one of said source fields to one of said search result fields.

13. The method as recited in claim 12 wherein said mapping from one of said source fields to one of said search result fields comprises visualizing said search domain sources and said format of the search results returned by the search engine.

14. A computer-readable medium carrying one or more sequences of instructions which, when executed by one or more processors, causes the one or more processors to perform the method recited in claim 1.

15. A computer-readable medium carrying one or more sequences of instructions which, when executed by one or more processors, causes the one or more processors to perform the method recited in claim 2.

16. A computer-readable medium carrying one or more sequences of instructions which, when executed by one or more processors, causes the one or more processors to perform the method recited in claim 3.

17. A computer-readable medium carrying one or more sequences of instructions which, when executed by one or more processors, causes the one or more processors to perform the method recited in claim 4.

18. A computer-readable medium carrying one or more sequences of instructions which, when executed by one or more processors, causes the one or more processors to perform the method recited in claim 5.

19. A computer-readable medium carrying one or more sequences of instructions which, when executed by one or more processors, causes the one or more processors to perform the method recited in claim 6.

20. A computer-readable medium carrying one or more sequences of instructions which, when executed by one or more processors, causes the one or more processors to perform the method recited in claim 7.

21. A computer-readable medium carrying one or more sequences of instructions which, when executed by one or more processors, causes the one or more processors to perform the method recited in claim 8.

22. A computer-readable medium carrying one or more sequences of instructions which, when executed by one or more processors, causes the one or more processors to perform the method recited in claim 9.

23. A computer-readable medium carrying one or more sequences of instructions which, when executed by one or more processors, causes the one or more processors to perform the method recited in claim 10.

24. A computer-readable medium carrying one or more sequences of instructions which, when executed by one or more processors, causes the one or more processors to perform the method recited in claim 11.

25. A computer-readable medium carrying one or more sequences of instructions which, when executed by one or more processors, causes the one or more processors to perform the method recited in claim 12.

26. A computer-readable medium carrying one or more sequences of instructions which, when executed by one or more processors, causes the one or more processors to perform the method recited in claim 13.

27. A system comprising:
a network;
one or more clients communicatively couples with said network; and
a server configured to perform steps that comprise:
generating a user interface for receiving parameters that specify properties of a search engine;
via the user interface, receiving certain parameters, from one or more of the clients, that specify the properties for a certain search engine;
configuring said certain search engine according to the parameters;
receiving, from one or more of the clients through the user interface, request for executing said search engine;
presenting, via the user interface, said search results generated by the execution of said search engine;
wherein the certain parameters specify each of a set of search engine properties that include:
the format of the search results returned by the search engine; and
search domain sources of said search engine.
